(19) United States
(12) Patent Application Publication
(10) Pub. No.: US 2014/0132421 A1
(43) Pub. Date: May 15, 2014

(54) REMOTE, REAL-TIME TEMPERATURE MONITORING FOR TEMPERATURE SENSITIVE ITEMS

(71) Applicant: Jeremy Beau Rathburn, Lancaster, OH (US)

(72) Inventor: Jeremy Beau Rathburn, Lancaster, OH (US)

(21) Appl. No.: 13/673,875

(22) Filed: Nov. 9, 2012

(51) Int. Cl. G08C 17/02

(52) U.S. Cl. CPC G08C 17/02
USPC 340/870.03

(57) ABSTRACT

A system and method remotely monitors, in real time, temperature conditions at one or more locations. The system can include small, stand-alone devices with a built-in communication device, such as a cellular modem. These devices can also include a GPS receiver to provide device location. A temperature reading can then be transmitted in real-time back to a central location, where immediate action can be taken upon receipt. Thresholds can also be established and an alert, such as a signal on a monitoring screen, an email alert, a text alert, or the like, or some combination thereof, can be reported immediately upon the occurrence of a temperature excursion above or below these thresholds. Appropriate action can be taken so that no user intervention is needed at the locations where the temperature is being monitored. By leveraging communication networks, such as cellular networks, the need for extensive network infrastructure is eliminated.

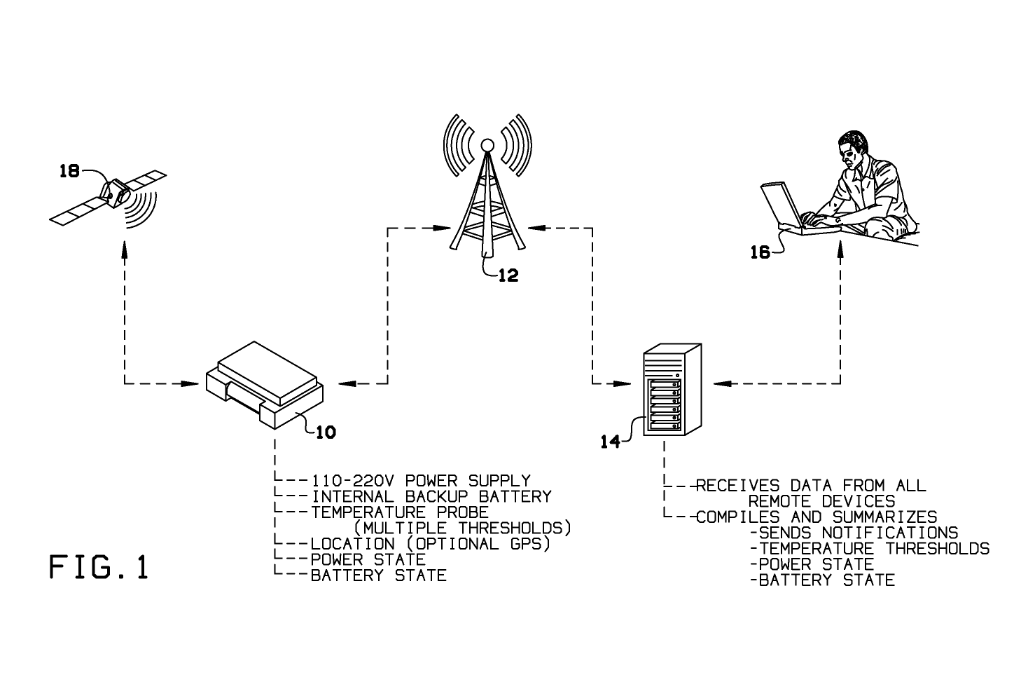

### BACKGROUND OF THE INVENTION

The present invention relates to temperature monitoring systems and methods and, more particularly, to systems and methods for remote, real-time temperature monitoring.

Many businesses have a need for collecting, analyzing and taking action based upon temperature readings in widely dispersed locations. Present solutions require an extensive network infrastructure, or rely on human intervention to upload a file generated by a temperature data logging device. Often, several days are lost in the transit and processing of temperature data before action can be taken. If immediate action is needed, with conventional temperature monitoring, a user must be present at the location where temperature controlled items are being monitored in order to take action.

As can be seen, there is a need for an improved system for the remote, real-time temperature monitoring of temperature sensitive items.

### SUMMARY OF THE INVENTION

In one aspect of the present invention, a system for remotely monitoring temperature comprises one or more remote monitoring devices having a temperature probe for detecting temperature; a wireless network adapted to send temperature data from the one or more remote monitoring devices to a central location; and one or more end user access data points configured to receive alerts from the central location.

In another aspect of the present invention, a system for remotely monitoring temperature comprises a plurality of remote monitoring devices having a temperature probe for detecting temperature; a wireless network adapted to send temperature data from the one or more remote monitoring devices to a central location; a global positioning system for sending data related to a location of the plurality of remote monitoring devices to the central location; and one or more end user access data points configured to receive alerts from the central location, the alerts including the location of a selected remote monitoring device and its real time temperature data.

In a further aspect of the present invention, a method for monitoring temperature remotely, in real time, in a plurality of locations comprises disposing a plurality of remote monitoring devices at locations where temperature monitoring is desired; sending temperature data from the remote monitoring devices to a central location; compiling and summarizing the temperature data; and sending the compiled and summarized temperature data to one or more user access data points for review by a user.

These and other features, aspects and advantages of the present invention will become better understood with reference to the following drawings, description and claims.

### BRIEF DESCRIPTION OF THE DRAWING

The FIGURE is a schematic representation of a system according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and method for remotely monitoring, in real time, temperature conditions at one or more locations. The system can include small, stand-alone devices with a built-in communication device, such as a cellular modem. These devices can also include a global positioning satellite (GPS) receiver to provide device location. A temperature reading can then be transmitted in real-time back to a central location, where immediate action can be taken, as needed, upon receipt. Thresholds can also be established and an alert can be reported immediately upon the occurrence of a temperature excursion above or below these thresholds. The alert can be a signal on a monitoring screen, an email alert, a text alert, or the like, or some combination thereof. Appropriate action can be taken, often remotely, so that no user intervention is needed at the locations where the temperature is being monitored. By leveraging communication networks, such as cellular networks, the need for extensive network infrastructure is eliminated.

Referring now to the Figure, a system for remotely monitoring temperature can include one or more remote monitoring devices 10. The remote monitoring devices 10 can include a power supply, which may be adapted to run on available power, such as 110V, 220V, or the like. An internal backup battery can be provided in the remote monitoring devices 10 to provide power in case of power failure. The remote monitoring devices 10 can also include a temperature probe for measuring temperature. The temperature probe can be made integrally with the remote monitoring device 10, or may be a probe electrically connected to the remote monitoring device 10.

The remote monitoring devices 10 can include optional features, such as a GPS receiver, a power state indicator and a battery state indicator. The GPS location, power state and battery state information can be sent, along with temperature data, as described below.

A wireless network 12 can be used to send data to and/or from the remote monitoring device(s) 10. The wireless network 12 can be, for example, a cellular network. The data can include temperature data, and, optionally, GPS data from a GPS satellite 18, power state data, battery state data and the like. Depending on the application, the temperature data can be sent in real time to a central location 14 and end user access data points 16 can be used to monitor the data. The temperature can be sent continuously, or can be polled periodically, such as every 5 minutes, or every 30 minutes, or the like.

The central location 14 can receive data from all of the remote devices 10. The central location 14 can compile and summarize the data and provide notifications to the end user access data point 16. The notifications can be provided based on one or more preset thresholds. Different notifications may be programmed for different thresholds. For example, a basic “all ok” message can be sent to the user access data point 16 periodically. If one threshold is breeched, then a first message can be sent to the user access data point 16. If a second threshold is breeched, for example, a different message can be sent to the user access data point 16. The user access data point 16 can be defined to be different devices, depending on the threshold breeched, for example. In some cases, the first message can be sent to a monitoring terminal, where a second message (for a further breech or excursion from a desired temperature set point) can be sent to multiple monitoring terminals, email addresses, SMS text numbers, or the like.

Not only can multiple thresholds be set, but timers can record how long above a certain threshold the temperature was held to determine safety of products stored at a given temperature or temperature. These timers can also control the type or number of alerts generated by the system.

Other monitoring accessories can be used with the system of the present invention. For example, a door open monitor, cooling compressor on monitor, fan monitors or the like can allow the user to remotely see status of various systems so that, if the temperature starts to climb, corrective action may be able to be taken quickly. For example, if a first temperature threshold is breeched, while the product stored inside may still be safe, if a door open monitor indicates a door to a cooling chamber has been open for an extended period, the appropriate corrective action may be simply to have the door closed, thereby correcting the issue that caused the first threshold to be breeched, allowing the temperature to decrease and keeping the product at a safe temperature.

The system of the present invention can provide reports of temperature readings and can store temperatures in a given compartment or obtained from a particular remote monitoring device 10. These reports can be used as needed, for example, drug stability testing may require the drugs to be placed in a 80 degree room for 30 days. Remote monitoring of the temperature of the storage chamber can allow multiple studies to happen at once, can provide data reports for the regulatory agency, and can allow quick response to proactively fix any issues so as not to have to destroy a batch or restart a study.

It should be understood, of course, that the foregoing relates to exemplary embodiments of the invention and that modifications may be made without departing from the spirit and scope of the invention as set forth in the following claims.

What is claimed is:

1. A system for remotely monitoring temperature comprising:
one or more remote monitoring devices having a temperature probe for detecting temperature;
a wireless network adapted to send temperature data from the one or more remote monitoring devices to a central location; and
one or more end user access data points configured to receive alerts from the central location.

2. The system of claim 1, wherein the one or more remote monitoring devices includes a plurality of remote monitoring devices.

3. The system of claim 1, further comprising a global positioning system for sending data related to a location of the one or more remote monitoring devices to the central location.

4. The system of claim 1, wherein the alerts include departure from one or more temperature thresholds.

5. The system of claim 1, wherein the alerts include a power state alert and a battery state alert.

6. A system for remotely monitoring temperature comprising:
a plurality of remote monitoring devices having a temperature probe for detecting temperature;
a wireless network adapted to send temperature data from the one or more remote monitoring devices to a central location;
a global positioning system for sending data related to a location of the plurality of remote monitoring devices to the central location; and
one or more end user access data points configured to receive alerts from the central location, the alerts including the location of a selected remote monitoring device and its real time temperature data.

7. The system of claim 6, wherein the alerts include departure from one or more temperature thresholds.

8. The system of claim 6, wherein the alerts include a power state alert and a battery state alert.

9. A method for monitoring temperature remotely, in real time, in a plurality of locations, the method comprising:
disposing a plurality of remote monitoring devices at locations where temperature monitoring is desired;
sending temperature data from the remote monitoring devices to a central location;
compiling and summarizing the temperature data; and
sending the compiled and summarized temperature data to one or more user access data points for review by a user.

10. The method of claim 9, further comprising sending location data from the plurality of remote monitoring devices to the central location.
